(19) United States
(12) Patent Application Publication
(10) Pub. No.: US 2008/0064258 A1
(43) Pub. Date: Mar. 13, 2008

(54) Electrical connector with improved fastener

(75) Inventor: Yi-Hung Kuan, Hsin-Chuang (TW)

Correspondence Address: WEI TE CHUNG;FOXCONN INTERNATIONAL, INC., 1650 MEMOREX DRIVE, SANTA CLARA, CA, 95050, US

(73) Assignee: TEKCON ELECTRONICS CORP.

(21) Appl. No.: 11/900,480

(22) Filed: Sep. 12, 2007

(30) Foreign Application Priority Data
Sep. 12, 2006 (TW) 95216255

(51) Int. Cl. H01R 13/66

(52) U.S. Cl. 439/574

(57) ABSTRACT

An electrical connector (100) includes an insulative housing (1), a number of contacts (2) retained in the insulative housing (1), a metal shell (5) partially enclosing the insulative housing, a pair of board locks (3) and a pair of fasteners (4) for assembling the board locks (3) and the metal shell (5) onto the insulative housing. Each fastener (4) includes a resisting portion (41) abutting against the board lock and a rivet portion (43) extending through the metal shell. The rivet portion (43) is hollow to form a recess (431) therein and defines a plurality of notches (432) to separate the rivet portion (43) into several discontinuous parts which are riveted to abut against the metal shell.

### BACKGROUND OF THE INVENTION

1. Field of the Invention

The present invention relates to an electrical connector, and more particularly to an electrical connector with improved fastener.

2. Description of the Prior Art

U.S. Pat. No. 6,679,727 B1 discloses a conventional electrical connector which comprises an insulative housing, a plurality of terminals received in the insulative housing, a shell enclosing the housing, a pair of board locks and a pair of fasteners for assembling the board locks onto the housing. Each fastener has a base plate and a hollow cylinder extending from the base plate. The hollow cylinder extends through a through hole of the board lock with the base plate abutting against the board lock on a rear side of the insulative housing. The hollow cylinder further comprises a rivet portion on a distal end thereof. The rivet portion is stamped outwardly to abut against a front surface of the shell on a front side of the insulative housing so that the electrical connector is assembled. However, since the rivet portion is continuous along its circumference, the rivet portion is avulsed and difficult in manufacture. Besides, during the riveted process, the avulsion of the continuous rivet portion might be anomalous so that the appearance of the electrical connector is not good enough.

Hence, an improved electrical connector is needed to solve the problem above.

### BRIEF SUMMARY OF THE INVENTION

A main object of the present invention is to provide an electrical connector with improved fastener for easy assembly thereof.

In order to attain the object above, an electrical connector includes an insulative housing, a plurality of contacts retained in the insulative housing, a metal shell enclosing the insulative housing, a pair of board locks and a pair of fasteners for assembling the board locks and the shell onto the insulative housing. The insulative housing defines a pair of apertures on lateral sides thereof. The shell defines a pair of through holes corresponding to the apertures. Each board lock defines a bore therethrough corresponding to the aperture. The through holes and the bores are positioned on opposite sides of the apertures for the fasteners extending therethrough. Each fastener extends through the bore, the aperture and the through hole in turn, and comprises a resisting portion abutting against the board lock and a rivet portion extending out of the insulative housing. The rivet portion is hollow to form a recess therein and defines a plurality of notches in communication with the recess to separate the rivet portion into a plurality of discontinuous parts. During riveted process, the discontinuous parts of the rivet portion are easy to be riveted to abut against the metal shell, thereby facilitating the manufacture of the electrical connector and improving the appearance of the electrical connector as well.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector before riveted process according to a preferred embodiment of the present invention;

FIG. 2 is similar to FIG. 1, but viewed from another aspect;

FIG. 3 is an exploded view of the electrical connector shown in FIG. 1; and

FIG. 4 is a perspective view of the electrical connector after riveted process.

### DETAILED DESCRIPTION OF THE PREFERRED EMBODIMENT

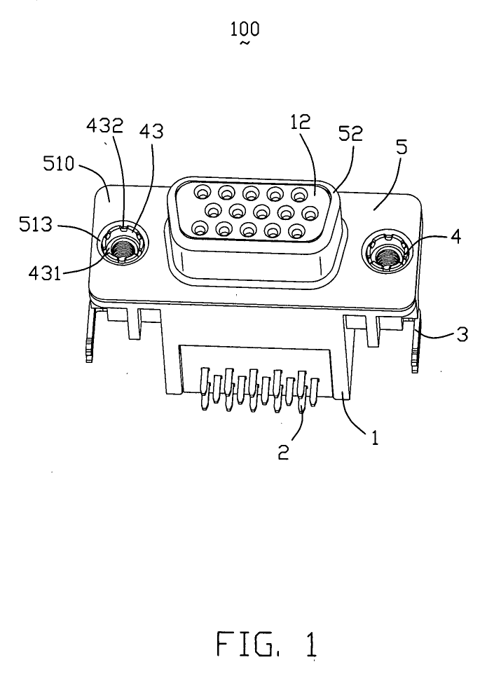

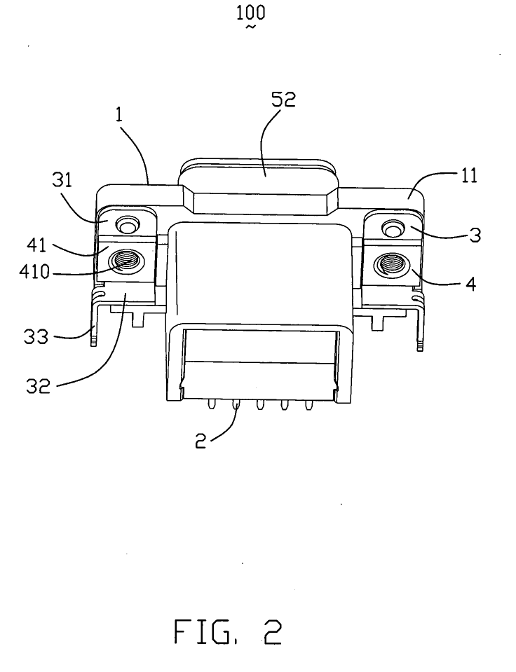

Referring to FIGS. 1-4, an electrical connector 100 includes an insulative housing 1, a plurality of contacts 2 retained in the insulative housing 1, a metal shell 5 enclosing the insulative housing 1, a pair of board locks 3 and a pair of fasteners 4 for assembling the board locks 3 and the metal shell 5 onto the insulative housing 1.

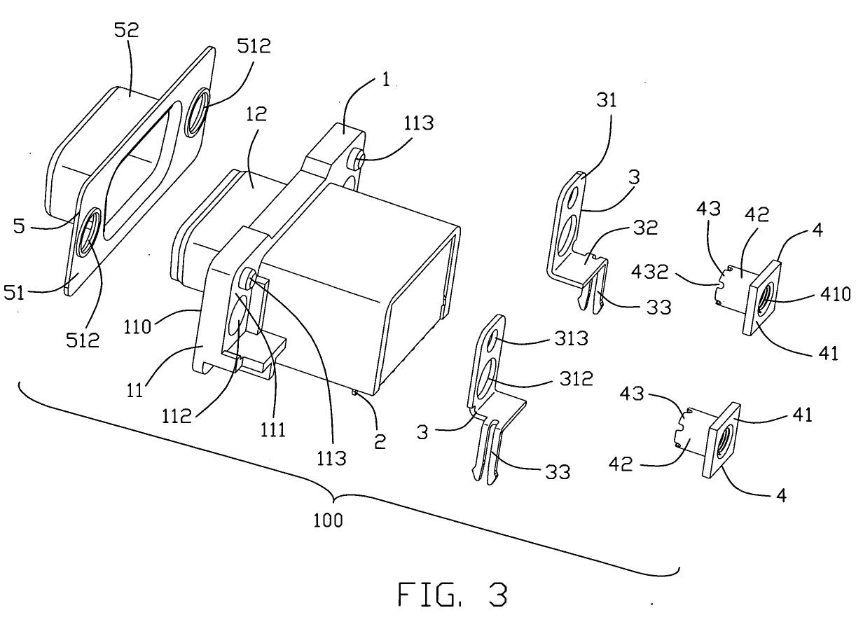

Referring to FIG. 3, the insulative housing 1 comprises a base portion 11 and a protrusion 12 extending from a front surface 110 of the base portion 11. The base portion 11 defines a pair of apertures 112 extending through the front surface 110 and a rear surface 111 thereof wherein the apertures 112 are positioned on lateral sides of the base portion 11.

The metal shell 5 comprises a flat mating portion 51 to be attached to the front surface 110 of the insulative housing 1 and a hollow D-shaped projection 52 protruding forwardly from the mating portion 51 for receiving the corresponding protrusion 12 of the insulative housing 1. The mating portion 51 defines a pair of through holes 512 on lateral sides thereof corresponding to the apertures 112. Besides, the metal shell 5 further defines a pair of depressions 513 in an out surface 510 thereof as shown in FIG. 1. The depressions 513 are in communication with the corresponding through holes 512. The depressions 513 are larger than the through holes 512 so that the fasteners 4 can be riveted to abut against the depressions 513.

Each board lock 3 comprises a vertical base 31, an extending portion 32 perpendicular to the base 31 and a pair of separated pawls 33 bending from the side edge of the extending portion 32. Each base 31 defines a bore 312 therethrough for receiving the fastener 4. In order to attach the board lock 3 to the rear surface 111 of the insulative housing 1, the rear surface 111 includes a pair of positioning posts 113 extending backwardly and each base 31 defines a guiding hole 313 for receiving the positioning posts 113.

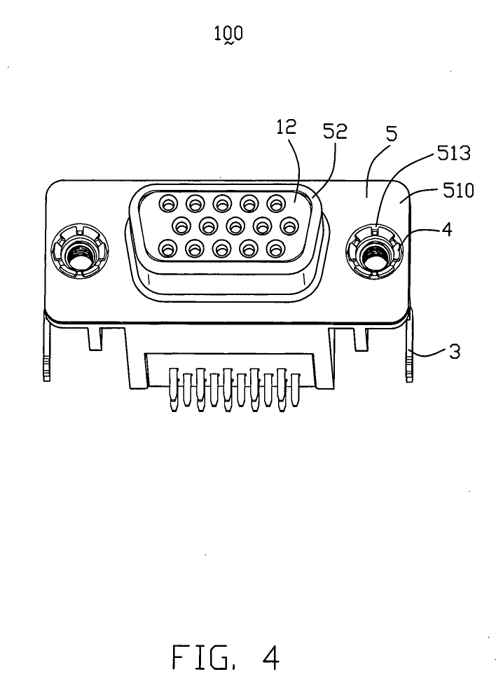

Referring to FIGS. 3-4, each fastener 4 is nut in the preferred embodiment and comprises a resisting portion 41, a cylinder-shaped extending section 42 extending forwardly from the resisting portion 41 and a rivet portion 43 positioned at the distal end of the extending section 42. The resisting portion 41 is much larger than the extending section 42 so that it can abut against the board locks 3 and allow the extending section 42 passing through the bore 312 and into the aperture 112. The rivet portion 43 extends beyond the aperture 112 to be riveted to abut against the metal shell 5. Each fastener 4 defines a plurality of inner screw threads 410 therein. The rivet portion 43 is hollow to form a recess 431 therein and defines a plurality of notches 432 in communication with the recess 431. The plurality of notches 432 are located along girth of the rivet portion 43 and separate the rivet portion 43 into several discontinuous parts. During riveted process, the discontinuous parts of the rivet portion 43 are easy to be riveted to abut against the depression 513 of the metal shell 5 shown in FIG. 4, thereby facilitating the manufacture of the electrical connector 100 and improving the appearance of the electrical connector 100 as well.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector, comprising:
an insulative housing defining an aperture therethrough;
a plurality of contacts retained in the insulative housing;
a metal shell defining a through hole corresponding to one side of the aperture;
a board lock comprising a base with a bore defined through the base, the bore being corresponding to the other side of the aperture; and
a fastener extending through the bore, the aperture and the through hole, the fastener comprising a resisting portion abutting against the base and a rivet portion extending beyond the aperture, the rivet portion being hollow to form a recess therein and defining a plurality of notches in communication with the recess to separate the rivet portion into several discontinuous parts, and wherein the discontinuous parts of the rivet portion are riveted to abut against the metal shell.

2. The electrical connector according to claim 1, wherein the fastener comprises an extending section protruding from the resisting portion with the rivet portion disposed at a distal end of the extending section, the extending section being received in the aperture.

3. The electrical connector according to claim 2, wherein the resisting portion is larger than the extending section.

4. The electrical connector according to claim 1, wherein the plurality of notches extend along girth of the rivet portion.

5. The electrical connector according to claim 1, wherein the metal shell comprises an out surface with the through hole defined therein, the out surface comprising a depression in communication with the through hole.

6. The electrical connector according to claim 5, wherein the depression is much larger than the through hole, the rivet portion being riveted to abut against the depression.

7. The electrical connector according to claim 1, wherein the fastener is nut and defines a plurality of inner screw threads recessed therein.

8. The electrical connector according to claim 1, wherein the insulative housing comprises a positioning post and the base of the board lock defines a guiding hole to receive the positioning post.

9. The electrical connector according to claim 1, wherein the board lock comprises a board-retaining portion extending from a side edge of the base.

10. An electrical connector, comprising:
an insulative housing defining a pair of apertures on lateral sides thereof;
a plurality of contacts retained in the insulative housing;
a metal shell defining a pair of through holes corresponding to the apertures;
a pair of board locks each defining a bore therethrough corresponding to the apertures; and
a pair of fasteners each extending through the bore, the aperture and the through hole in turn, each fastener comprising a resisting portion abutting against the board lock and a rivet portion extending beyond the aperture, the rivet portion being hollow to form a recess therein and defining a plurality of notches in communication with the recess to separate the rivet portion into several discontinuous parts, and wherein the discontinuous parts of the rivet portion are riveted to abut against the metal shell.

11. The electrical connector according to claim 10, wherein each fastener comprises an extending section protruding from the resisting portion with the rivet portion disposed at a distal end of the extending section, the extending section being received in the aperture.

12. The electrical connector according to claim 11, wherein the resisting portion is larger than the extending section.

13. The electrical connector according to claim 10, wherein the plurality of notches extend along girth of the rivet portion.

14. The electrical connector according to claim 10, wherein the metal shell comprises an out surface with the through hole defined therein, the out surface comprising a depression in communication with the through hole, and wherein the rivet portion is riveted to abut against the depression.

15. An electrical connector comprising:
an insulative housing defining an aperture therethrough;
a plurality of contacts retained in the insulative housing;
a metal shell defining a through hole corresponding to one side of the aperture;
a board lock comprising a base with a bore defined through the base, the bore being corresponding to the other side of the aperture; and
a fastener extending through the bore, the aperture and the through hole, the fastener comprising a resisting portion abutting against the base and a rivet portion extending beyond the aperture, the rivet portion being hollow to form a recess therein; wherein
a front rim region of said fastener is not circumferentially continuously constantly dimensioned so as to make it easy to rearwardly rivet said front rim region against the metal shell.

16. The electrical connector as claimed in claim 15, wherein the front rim region is split with a plurality of diverging parts with notches each between every adjacent two corresponding diverging parts.
